(19) United States
(12) Patent Application Publication
(10) Pub. No.: US 2026/0219964 A1
(43) Pub. Date: Jul. 30, 2026

(54) INFORMATION HANDLING SYSTEM WITH A QUALITY OF SERVICE MODEL CONTRACT PIPELINE

(71) Applicant: DELL PRODUCTS L.P., Round Rock, TX (US)

(72) Inventors: Srikanth Kondapi, Austin, TX (US); Tyler Cox, Austin, TX (US); Spencer Bull, Conroe, TX (US); Jacob Mink, Cedar Park, TX (US)

(21) Appl. No.: 19/036,992

(22) Filed: Jan. 24, 2025

(51) Int. Cl. G06F 9/54

(52) U.S. Cl. CPC G06F 9/54

(57) ABSTRACT

An information handling stores machine learning (ML) models and quality of service (QoS) data. The system performs a registration operation for multiple model management frame (MMF) core contracts and multiple supporting MMF converted modules (MCMs). Each different one of the MMF core contracts is supported by a corresponding different one of the MCMs. The system receives an application programming interface (API) request. In response to the API request, the system performs a learn operation for a first ML model and determines that a first MCM is to be used to respond to the API request. The system determines that the first ML model is associated with the first MCM and executes the first ML model via the first MCM to generate output data for a response to the API request.

### FIELD OF THE DISCLOSURE

The present disclosure generally relates to information handling systems, and more particularly relates to ensuring accuracy for a quality of service model contract of a pipeline within an information handling system.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system may store machine learning (ML) models and quality of service (QoS) data. The system may perform a registration operation for multiple model management frame (MMF) core contracts and multiple supporting MMF converted modules (MCMs). Each different one of the MMF core contracts is supported by a corresponding different one of the MCMs. The system may receive an application programming interface (API) request. In response to the API request, the system may perform a learn operation for a first ML model and determine that a first MCM is to be used to respond to the API request. The system may determine that the first ML model is associated with the first MCM and execute the first ML model via the first MCM to generate output data for a response to the API request.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an information handling system according to at least one embodiment of the present disclosure;

FIG. 2 is a flow diagram of a method for ensuring accuracy for a quality of service model contract of a pipeline within an information handling system according to at least one embodiment of the present disclosure; and

FIG. 3 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

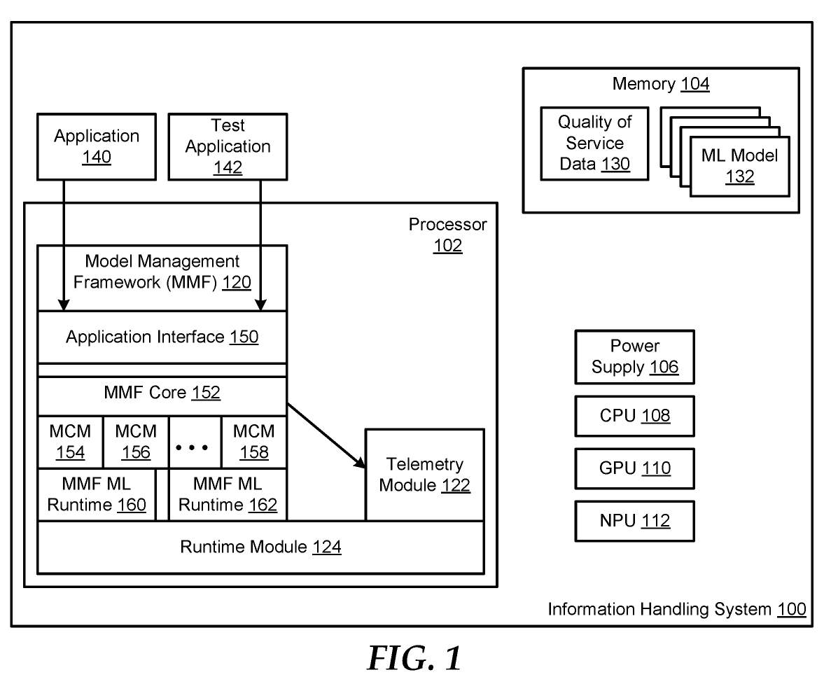

FIG. 1 illustrates an information handling system 100 according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 100 includes a processor 102, a memory 104, a power supply 106, a central processing unit (CPU) 108, a graphics processing unit (GPU) 110, and a neural processing unit (NPU) 112. Processor 102 includes a model management framework (MMF), a telemetry module 122, and a runtime module 124. Memory 104 may store quality of service (QoS) data and multiple machine learning (ML) models 132. Application 140 and test application 142 may be executed within information handling system 100 as will be described herein. MMF 120 includes an application interface 150, a MMF core 152, multiple MMF converted modules (MCMs) 154, 156, and 158, and MMF ML model runtime modules 160 and 162. Information handling system 100 may include additional components without varying from the scope of this disclosure.

During operation of information handling system 100, telemetry module 122 may monitor and collection data associated with MMF core 152, CPU 108, GPU 110, and NPU 112. For example, telemetry module 122 may collect device metrics for CPU 108, GPU 110, and NPU 112. Applications 140 and 142 may utilize application interface 150 to communicate with MMF 120 and MMF core 152, such that the applications may provide application programming interface (API) request to MMF 120 via application interface 150. In an example, application interface 150 may be any suitable interface including, but not limited to, a representational state transfer (REST) server, a custom communication over a pipe, any type of remote procedure call (RPC or gRPC), and web sockets.

In certain examples, MMF 120 may include multiple MMF core contracts, which in turn may be a set of rules and responsibilities within information handling system 100. These MMF core contracts may provide an interface or use case that may be supported by a ML model, such as audio transcription, text generation, image augmentation, or the like. In this situation, the MMF core contracts may describe required/optional inputs to the ML model and the expected outputs of the ML model. Additionally, invokable ML model APIs, through application interface 150 may be based on the MMF core contracts. In certain examples ML models 132 may be any suitable type of model, such as inference models to make predictions or decisions based on data received from applications 140 and 142.

Applications 140 and 142 may be line of business (LOB) applications that include artificial intelligence (AI) applications, such as conversational AI applications, also referred to as chatbots, which are used by various enterprise client devices. For example, more and more organizations adopt chatbots to support their customers in customer service and technical support. In certain examples, MMF 120 and MCMs 154, 156, and 158 may facilitate the consumption of AI device-enabled AI capabilities within LOB applications 14 and 142. In an enterprise environment, an information technology administrator typically deploys LOB applications to a fleet of client devices using remote management solutions. However, tracking and/or coordinating the complex and increasing number of dependencies of applications on MMF 120 and MCMs 154, 156, and 158 in a diverse AI computing ecosystem is increasingly becoming difficult.

In an example, MCMs 154, 156, and 158 may utilize ML model runtime modules 160 and 162 to execute trained ML models. Within ML model runtime modules 160 and 162, the ML models may receive data from application 140 or 142, perform one or more hidden operations on the data, and provide outputs to the application. ML model runtime modules 160 and 162 may be optimized for speed and scalability to handle real-time API requests. For example, ML model runtime modules 160 and 162 may receive API requests, route the requests to the appropriate ML model, and return the output of the ML model.

During operation of information handling system, processor 102 may utilize MMF core 152 to perform a registration operation for MMF core contracts and MCMs 154, 156, and 156. In an example, the MMF core contracts may include, but are not limited to, chat completion and transcription. The registration operation may be triggered by any suitable event, such as MMF 120 discovering and loading ML model or the like. In an example, MMF 120 may first discover and load a ML model in response to different events including, but not limited to, an installer completing install of the ML model and on the start of information handling system 100. During one of these events, MMF 120 may build the mappings for that model. In response to discovery and loading of the ML model, processor may perform the registration operation to determine relationships between the MMF core contracts and supporting MCMs 154, 156, and 158 and map MMF core contracts to corresponding ML models. In certain examples, the registration operation may determine or set relationships between the different MMF core contracts and the different MCMs 154, 156, and 158. For example during the registration operation, a different one of MCM 154, 156, and 158 is set as the supporting MCM for a different one of the MMF core contracts on a one-to-one basis. Similarly, a different one of the MMF core contracts is mapped to a different ML model on a one-to-one basis.

In certain examples, MMF 120 may trigger a new registration operation each time it adds a new MCM, information handling system has a physical configuration change or a software/firmware change related to AI accelerator hardware, or the like. In an example, the new learning operation may be batched based on most-used ML models. In this example, processor 102 may perform the learn operation on the different batch sets individually to avoid overloading information handling system 100 with AI requests every time the configuration of the information handling system changes.

During a learn operation, processor 102 may dynamically compute the benchmark data, such as workload characterization and ML models accuracy based on different parameters that impact performance of the ML models 132. The ML model impacting parameters may include, but are not limited to, ML model selection, quantization techniques such as post-training, conversion techniques such as hardware aware, framework aware, ML model runtime, and resource management of power supply 106, CPU 108, GPU 110, and NPU 112. In an example, the benchmark data may be determined by processor 102 executing prebuilt workloads on information handling system 100 under various system workload conditions. In certain examples, synthetic workloads may be used during the learn operation to simulate different workload conditions. At the completion of the learn operation, processor 102 may store data associated with the learn operation in memory. In an example, the data may include the determined relationships between the MMF core contracts and the MCMs 154, 156, and 158.

In an example, MMF 120 may receive an API request from application 140 via application interface 150. The API request may include a ML model and quality of service (QoS) parameters for the ML model. In response to the API request being received, processor 102 may determine the QoS parameters for the API request. In an example, the QoS parameters may include, but are not limited to, application contract level parameters, satisfy with ML model selection parameters, quantization parameters, conversion parameters, runtime parameters, resource management targets to deliver experience, and accuracy of the ML model.

Processor 102 may utilize the data associated with the learn operation to identify a MCM to respond to the API request. In particular, processor 102 may determine one of MCMs 154, 156, and 158 that may execute the ML model while accomplishing the QoS parameters, such as meeting the ML model accuracy QoS parameter. For example, MCM 154 may be identified as the MCM to execute the ML model of the API request. After MCM 154 completes the execution of the ML model, MMF 120 may provide the results of the ML model to application 140 via application interface 150.

As described herein, information handling system 100 is improved by MMF 120 of processor 102 managing various system and model constraints to meet an accuracy QoS of a ML model. In particular, processor 102 may perform a learn operation to determine system and ML model parameter impacts localized to information handling system 100. These system and ML model parameter impacts are utilized by processor 102 to select one of MCMs 154, 156, and 158 to perform the operations of a ML model associated with an API request.

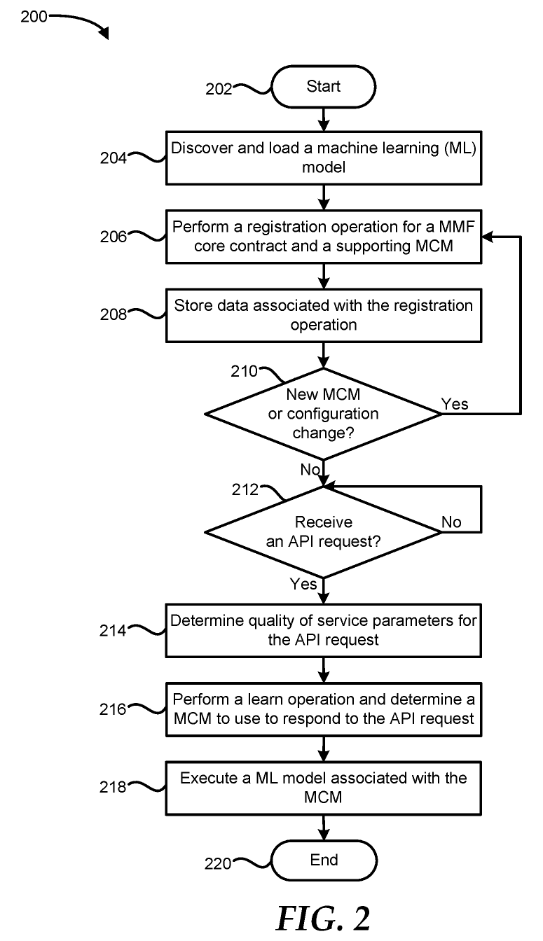

FIG. 2 shows a method 200 for ensuring accuracy of a quality of service model contract in a pipeline within an information handling system according to at least one embodiment of the present disclosure, starting at block 202. Not every method step set forth in this flow diagram is always necessary, and certain steps of the methods may be combined, performed simultaneously, in a different order, or perhaps omitted, without varying from the scope of the disclosure. FIG. 2 may be employed in whole, or in part, processor 102 of information handling system 100 in FIG. 1, or any other type of controller, device, module, processor, or any combination thereof, operable to employ all, or portions of, the method of FIG. 2.

At block 204, a ML model is discovered and loaded in an information handling system. In an example, the discovery and loading of the ML model may provide a registration-time event to trigger a configuration or determination of relationships between different model management frame (MMF) core contracts and different supporting MMF converted modules (MCMs). At block 206, a registration operation is performed for the MMF core contracts and the supporting MCMs and for MMF core contracts and ML models. In certain examples, the registration operation may determine or set relationships between the different MMF core contracts and the different MCMs and map MMF core contracts to corresponding ML models. For example, during the registration operation, a different MCM is set as the supporting MCM for a different MMF core contract on a one-to-one basis. Similarly, a different one of the MMF core contracts is mapped to a different ML model on a one-to-one basis.

At block 208, data associated with the registration operation is stored. The data may be stored in a memory of the information handling system. In an example, the data may include the determined relationships between the MMF core contracts and the MCMs. The data may also include the benchmark data for the MMF core contracts and MCMs pairs. In certain examples, the benchmark data may include, but is not limited to, workload characterization and machine learning (ML) models accuracy based on different ML model impacting parameters. In an example, the ML model impacting parameters may include, but are not limited to, ML model selection, quantization techniques such as post-training, conversion techniques such as hardware aware, framework aware, ML model runtime, and resource management targets.

At block 210, a determination is made whether a new MCM is added to the information handling system or a hardware or firmware change is made in the information handling. The new MCM may be added within the MMF of the processor. In certain examples, the hardware change may result in a physical configuration change of the information handling system. In an example, not all firmware changes on the information handling system may trigger this determination. For example, only software/firmware changes related to artificial intelligence (AI) accelerator hardware may trigger or make this determination true.

If a configuration change is made or a new MCM is added, the flow continues as stated above at block 206. In an example, the new learning operation may be batched based on most-used ML models. In this example, the different batch sets may be executed via the new learning operation individually to avoid overloading the information handling system with AI requests every time the configuration of the information handling system changes.

In response to no change being made and no new MCM being added, a determination is made whether an API request is received from an application at block 212. The API request may include a ML model and quality of service (QoS) parameters for the ML model. In response to the API request being received, the QoS parameters are determined for the API request at block 212. In an example the QoS parameters may include, but are not limited to, application contract level parameters, satisfy with ML model selection parameters, quantization parameters, conversion parameters, runtime parameters, resource management targets to deliver experience, and accuracy of the ML model.

At block 216, a learn operation is performed and a MCM to use to respond to the API request is determined. In an example, the MCM is determined based on the data stored in the memory during the learn operations for determining the MMF core contracts and MCMs relationships. At block 218, a ML model associated with the MCM is executed and the flow ends at block 220. In certain examples, the execution of the ML model generates an output, which in turn is provided to a source device associated with the API request. In an example, the API request may trigger the learn operation to determine data about the ML model in real-time. For example, the learn operation may include the benchmark data for the MMF core contracts and MCMs pairs. In certain examples, the benchmark data may include, but is not limited to, workload characterization and ML models accuracy based on different ML model impacting parameters. In an example, the ML model impacting parameters may include, but are not limited to, ML model selection, quantization techniques such as post-training, conversion techniques such as hardware aware, framework aware, ML model runtime, and resource management targets.

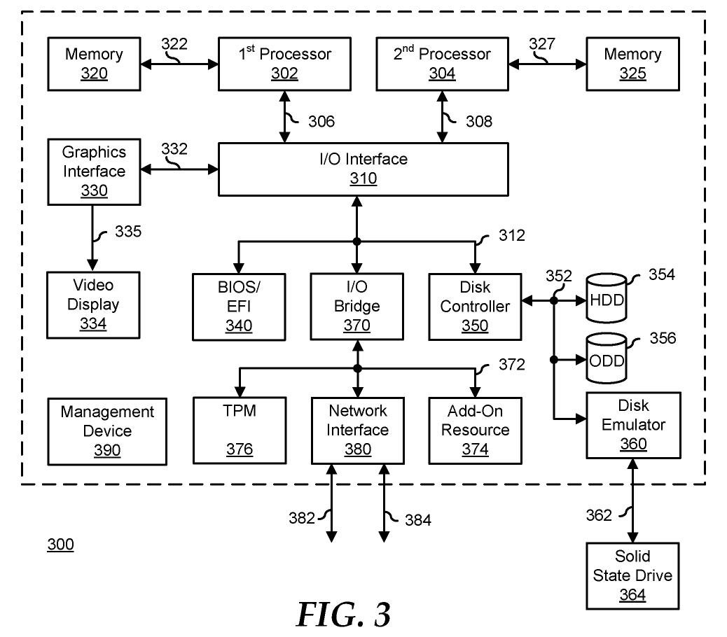

FIG. 3 shows a generalized embodiment of an information handling system 300 according to an embodiment of the present disclosure. Information handling system 300 may be substantially similar to information handling system 100 of FIG. 1. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356 , a disk emulator 360 connected to an external solid state drive (SSD) 364, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 364, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332 and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 4394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312 or can be a different type of interface. As such, I/O bridge 370 extends the capacity of I/O channel 312 when peripheral interface 372 and the I/O channel are of the same type, and the I/O bridge translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300.

Management device 390 can operate off of a separate power plane from the components of the host environment so that the management device receives power to manage information handling system 300 when the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a memory to store a plurality of machine learning (ML) models and quality of service (QoS) data; and
a processor to communicate with the memory, the processor to:
perform a registration operation for a plurality of model management frame (MMF) core contracts and a plurality of supporting MMF converted modules (MCMs), wherein each different one of the MMF core contracts is supported by a corresponding different one of the MCMs;
receive an application programming interface (API) request including a first ML model;
in response to the API request, perform a learn operation for the first ML model and determine that a first MCM of the plurality of MCMs is to be used to respond to the API request; and
execute the first ML model via the first MCM to generate output data as a response to the API request.

2. The information handling system of claim 1, wherein the plurality of MCMs are located within an MMF of the processor.

3. The information handling system of claim 2, wherein the processor further to:
determine that a new MCM is added in the MMF; and
perform a new registration operation for the plurality of MMF core contracts and the plurality of supporting MCMs including the new MCM.

4. The information handling system of claim 3, wherein the new registration operation further includes the processor further to: batch the new registration operation based on a most used ML models of the ML models.

5. The information handling system of claim 1, wherein the API request includes accuracy of the first ML model as a QoS parameter.

6. The information handling system of claim 1, wherein the learn operation further includes the processor to: dynamically determine benchmark data for the ML models based on prebuilt workloads.

7. The information handling system of claim 6, wherein the benchmark data includes a workload characterization and accuracy of the ML models based on different parameters that impact the ML models.

8. The information handling system of claim 1, wherein the processor further to:
determine that a physical configuration change has occurred in the information handling system; and
based on the physical configuration change, perform a new learn operation for the plurality of MMF core contracts and the plurality of supporting MCMs.

9. The information handling system of claim 1, wherein the determination that the first MCM is to be used to respond to the API request is based on data stored from the learn operation.

10. A method comprising:
storing, in a memory of an information handling system, a plurality of machine learning (ML) models and quality of service (QoS) data;
performing, by a processor of the information handling system, a registration operation for a plurality of model management frame (MMF) core contracts and a plurality of supporting MMF converted modules (MCMs), wherein each different one of the MMF core contracts is supported by a corresponding different one of the MCMs;
receiving an application programming interface (API) request including a first ML model;
in response to the API request, performing a learn operation for the first ML model and determining that a first MCM of the plurality of MCMs is to be used to respond to the API request; and
executing, by the processor, the first ML model via the first MCM to generate output data as a response to the API request.

11. The method of claim 10, wherein the plurality of MCMs are located within a MMF of the processor.

12. The method of claim 11, further comprising:
determining that a new MCM is added in the MMF; and
performing a new registration operation for the plurality of MMF core contracts and the plurality of supporting MCMs including the new MCM.

13. The method of claim 12, wherein the new registration operation includes the method further comprising: batching the new registration operation based on a most used ML models of the ML models.

14. The method of claim 10, wherein the API request includes accuracy of the first ML model as a QoS parameter.

15. The method of claim 10, wherein the learn operation further includes the method further comprising: dynamically determining benchmark data for the ML models based on prebuilt workloads.

16. The method of claim 15, wherein the benchmark data includes a workload characterization and accuracy of the ML models based on different parameters that impact the ML models.

17. The method of claim 10, further comprising:
determining that a physical configuration change has occurred in the information handling system; and
based on the physical configuration change, performing a registration learn operation for the plurality of MMF core contracts and the plurality of supporting MCMs.

18. The method of claim 10, wherein the determination that the first MCM is to be used to respond to the API request is based on data stored from the learn operation.

19. An information handling system comprising:
a memory to store a plurality of machine learning (ML) models and quality of service (QoS) data; and
a processor to:
perform a registration operation for a plurality of model management frame (MMF) core contracts and a plurality of supporting MMF converted modules (MCMs), wherein each different one of the MMF core contracts is supported by a corresponding different one of the MCMs;
receive an application programming interface (API) request including a first ML model and accuracy of the first ML model as a QoS parameter;
in response to the API request, perform a learn operation for the first ML model and determine that a first MCM of the plurality of MCMs is to be used to respond to the API request, wherein the first MCM provides a highest level of accuracy for the first ML; and
execute the first ML model via the first MCM to generate output data as a response to the API request.

20. The information handling system of claim 19, wherein the processor further to:
determine that a new MCM is added in the MMF; and
perform a new registration operation for the plurality of MMF core contracts and the plurality of supporting MCMs including the new MCM.
